(19) United States
(12) Patent Application Publication
(10) Pub. No.: US 2026/0267908 A1
(43) Pub. Date: Sep. 10, 2026

(54) MULTIMEDIA CONTENT GENERATION METHOD, APPARATUS, ELECTRONIC DEVICE, MEDIUM, AND PROGRAM PRODUCT

(71) Applicant: Beijing Zitiao Network Technology Co., Ltd., Beijing (CN)

(72) Inventors: Hui SUN, Beijing (CN); Rong ZOU, Beijing (CN)

(21) Appl. No.: 19/537,327

(22) Filed: Feb. 11, 2026

(30) Foreign Application Priority Data
Mar. 4, 2025 (CN) 202510252607.7

(51) Int. Cl. G06F 16/48; G06F 3/0482; G06F 16/683; G10H 1/00

(52) U.S. Cl. CPC G06F 16/48; G06F 3/0482; G06F 16/683; G10H 1/0025

(57) ABSTRACT

The present disclosure relates to a multimedia content generation method, an apparatus, an electronic device, a medium, and a program product, and relates to the field of artificial intelligence and computer technologies. The multimedia content generation method of the present disclosure includes: receiving an image; generating a music description text by understanding the image in a plurality of attribute dimensions , wherein the music description text comprises description information of a generated feature of music; determining the music according to the music description text; and generating the multimedia content according to the image and the music, and displaying the multimedia content.

### CROSS-REFERENCE TO RELATED APPLICATIONS

This application claims the benefit under 35 USC 119(a) of Chinese Patent Application No. 202510252607.7, filed on March 4, 2025. The entire disclosure of the prior application is hereby incorporated by reference in its entirety.

### TECHNICAL FIELD

The present disclosure relates to the field of artificial intelligence and computer technologies, and in particular, to a multimedia content generation method and apparatus, an electronic device, a medium, and a program product.

### BACKGROUND

With the development of Artificial Intelligence (AI) technology, generative models are constantly updated and iterated. At present, users may easily implement the transformation from creativity to generative content through some applications based on generative models. For example, the user only needs to input a simple text description in the application to generate an image with one click, or the user may input an image in the application to generate a video.

### SUMMARY

According to some embodiments of the present disclosure, a multimedia content generation method is provided, including: receiving an image; generating a music description text by understanding the image in a plurality of attribute dimensions, wherein the music description text comprises description information of a generated feature of music; determining music according to the music description text; and generating multimedia content according to the image and the music, and displaying the multimedia content.

According to some other embodiments of the present disclosure, a multimedia content generation apparatus is provided, including: a receiving module, configured to receive an image; a first generation module, configured to understand the image in a plurality of attribute dimensions to generate a music description text, where the music description text includes description information of a generated feature of music; a determination module, configured to determine music according to the music description text; a second generation module, configured to generate multimedia content according to the image and the music; and a display module, configured to display the multimedia content.

According to some further embodiments of the present disclosure, an electronic device is provided, including: a processor; and a memory coupled to the processor and configured to store instructions, where the instructions, when executed by the processor, cause the processor to implement the multimedia content generation method according to any one of the embodiments of the present disclosure.

According to some still further embodiments of the present disclosure, a computer-readable storage medium is provided, where a computer program is stored on the computer-readable storage medium, and the computer program, when executed by a processor, implements the multimedia content generation method according to any one of the embodiments of the present disclosure.

According to some yet further embodiments of the present disclosure, a computer program product is provided, including: instructions, where the instructions, when executed by a processor, cause the processor to implement the multimedia content generation method according to any one of the embodiments of the present disclosure.

Other features, aspects, and advantages of the present disclosure become apparent with reference to the following detailed description of exemplary embodiments of the present disclosure and in conjunction with the drawings.

### BRIEF DESCRIPTION OF THE DRAWINGS

Embodiments of the present disclosure are described below with reference to the drawings. It should be understood that the drawings in the following description relate only to some embodiments of the present disclosure, but do not constitute a limitation to the present disclosure. In the drawings:

FIG. 1 is a schematic flowchart of a multimedia content generation method according to some embodiments of the present disclosure;

FIG. 2 is a schematic diagram of an interaction interface according to some embodiments of the present disclosure;

FIG. 3 is a schematic diagram of an interaction interface according to some other embodiments of the present disclosure;

FIG. 4 is a schematic diagram of an interaction interface according to some further embodiments of the present disclosure;

FIG. 5 is a schematic diagram of a structure of a multimedia content generation apparatus according to some embodiments of the present disclosure;

FIG. 6 is a schematic diagram of a structure of an electronic device according to some embodiments of the present disclosure;

FIG. 7 is a schematic diagram of a structure of an electronic device according to some other embodiments of the present disclosure.

### DETAILED DESCRIPTION

The technical solutions in the embodiments of the present disclosure are clearly and completely described below with reference to the drawings in the embodiments of the present disclosure. It should be understood that the present disclosure may be implemented in various forms, and should not be construed as limited to the embodiments set forth herein.

It should be understood that steps described in method implementations of the present disclosure may be performed in different orders and/or in parallel. In addition, the method implementations may include additional steps and/or omit performing illustrated steps. The scope of the present disclosure is not limited in this respect. Unless otherwise specifically stated, relative arrangements of the steps set forth in these embodiments should be construed as merely exemplary, and do not limit the scope of the present disclosure.

The term "include/comprise" and variations thereof used in the present disclosure mean open terms that at least include the following elements/features, but do not exclude other elements/features, that is, "include/comprise but not limited to". The term "based on" means "at least partially based on".

It should be noted that concepts such as "first" and "second" mentioned in the present disclosure are merely used to distinguish between different apparatuses, modules, or units, and are not used to limit an order or interdependence of the functions performed by these apparatuses, modules, or units. Unless otherwise specified, concepts such as "first" and "second" are not intended to imply that objects described as such must be in a given order in terms of time, space, ranking, or in any other manner.

It should be noted that modifications of "one" and "a plurality of" mentioned in the present disclosure are illustrative rather than restrictive, and those skilled in the art should understand that unless otherwise clearly indicated in the context, the modifications should be construed as "one or more".

Names of messages or information exchanged between a plurality of apparatuses in the implementations of the present disclosure are used for illustrative purposes only, and are not used to limit the scope of these messages or information.

It should be understood that the present disclosure does not limit how to obtain an image to be applied/processed. In some embodiments of the present disclosure, the image may be obtained from a storage apparatus, such as an internal memory or an external storage apparatus. In some other embodiments of the present disclosure, a photographing component may be mobilized to take a photo. It should be noted that the obtained image may be an acquired image, or a frame of image in an acquired video, which is not particularly limited thereto.

In the context of the present disclosure, an image may refer to any of a variety of images, such as a color image, a gray image, etc. It should be pointed out that in the context of this specification, the type of the image is not specifically limited. In addition, the image may be any appropriate image, for example, an original image obtained by a photographing apparatus, or an image that has been subjected to specific processing on the original image, such as preliminary filtering, anti-aliasing, color adjustment, contrast adjustment, normalization, etc. It should be pointed out that the pre-processing operations may also include other types of pre-processing operations known in the art, which will not be described in detail here.

The embodiments of the present disclosure are described in detail below with reference to the drawings, but the present disclosure is not limited to these specific embodiments. The following specific embodiments may be combined with each other, and the same or similar concepts or processes may not be repeated in some embodiments. In addition, in one or more embodiments, a specific feature, structure, or characteristic may be combined in any suitable manner that will be clear to those of ordinary skill in the art from the present disclosure.

At present, some applications or agents may provide a function of generating a video based on an image. The generated video usually has no music added, and even if music is added, it is some default background music.

The music in a video may enhance emotional resonance, create atmosphere, etc., so that the overall effect of the video is better. In many cases, users desire that the generated video has music, and in some cases, users desire to generate a music video based on an image. However, adding default background music in a video is usually less relevant to the content of the image or the video, resulting in a poor effect and failing to meet the needs of users. If users add music and edit videos by themselves, the operation is complicated and inefficient.

For the foregoing reasons, the present disclosure provides a multimedia content generation method. According to the method, an image input by a user is understood in a plurality of attribute dimensions to generate a music description text, music is determined according to the music description text, and multimedia content is generated according to the image and the music. Because the music description text is generated based on understanding of the image in the plurality of attribute dimensions, a generated feature of music described in the music description text is associated with the plurality of attribute dimensions of the image, so that the generated music matches the image, and the finally the generated multimedia content also matches the music. This may improve the presentation effect and audio-visual effect of the multimedia content as a whole, and better meet the needs of users. According to the multimedia content generation method of the present disclosure, the music may be directly determined and the multimedia content may be directly generated based on the image without the need for the user to select and add music, so that the efficiency of generating the multimedia content is improved while the presentation effect and audio-visual effect of the multimedia content are improved.

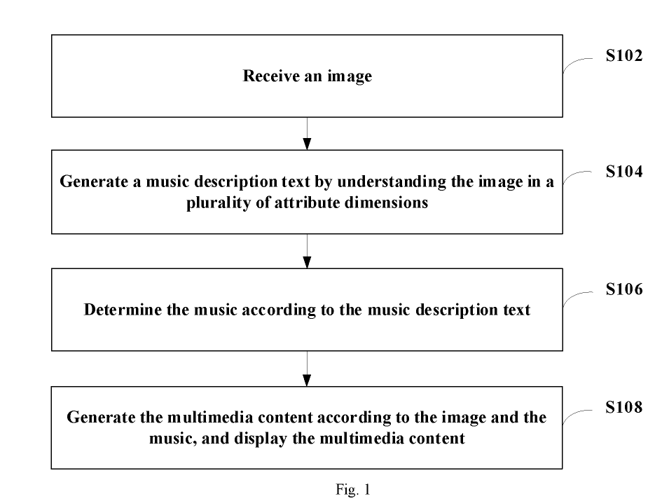

The multimedia content generation method of the present disclosure is described below with reference to FIGS. 1 to 4. The multimedia content generation method of the present disclosure may be performed by at least one of an application, an agent, a robot (Bot), a multimedia content generation apparatus, and an electronic device, but is not limited to the examples.

FIG. 1 is a flowchart of some embodiments of a multimedia content generation method of the present disclosure. As shown in FIG. 1, the method in this embodiment includes steps S102 to S108.

In step S102, an image is received.

For example, a user may input the image in an interaction interface, and the interaction interface may be an interaction interface provided by an application, an agent, a robot, a multimedia content generation apparatus, an electronic device, etc. The image may be acquired from an internal storage apparatus or an external storage apparatus of an electronic device (such as a terminal) used by the user, or may be captured by calling a photographing component in the electronic device used by the user, which is not limited to the examples.

In step S104: a music description text is generated by understanding the image in a plurality of attribute dimensions, where the music description text includes description information of a generated feature of music.

For example, a machine learning model may be used to understand the image in the plurality of attribute dimensions to generate the music description text. The attributes of the image may be various properties and characteristics that may describe and portray the features of the image. Understanding the image in the plurality of attribute dimensions may be analyzing and understanding the image in the plurality of attribute dimensions using the machine learning model, or analyzing and understanding various attributes of the image. For example, the plurality of attribute dimensions may include at least two of an entity, a scene, emotion, an environment, a theme, a style, and an effect element, which is not limited to the examples. The plurality of attribute dimensions may be pre-configured, or may be a plurality of attribute dimensions that need to be understood for the image and that are determined by the machine learning model based on a task of generating the music description text.

By understanding the image in the plurality of attribute dimensions, some features of the music may be generated, and the generated feature of the music may be obtained. Then, the description text of the music is determined according to the generated feature of the music, and the music description text may be used to describe the features (generated features) of the music to be determined subsequently. For example, the generated feature of the music includes a feature(s) corresponding to at least one feature type of atmosphere, style, rhythm, melody, harmony, timbre, and vocals, which is not limited to the examples. The at least one feature type to which the generated feature of the music belongs may be preset, or may be at least one feature type required for generating the music and determined by a subsequent task of generating the music by the machine learning model.

The music may be with or without lyrics, and may be selected by the user. In a case where the music includes lyrics, the image is understood in the plurality of attribute dimensions to generate the lyrics of the music, and the music description text is generated according to the lyrics of the music and the generated feature of the music, that is, the music description text may further include the lyrics of the music.

By understanding the image in the plurality of attribute dimensions to generate description information of the features of the music and lyrics, the subsequently determined music may be closely associated and matched with the image, so that the music may express information, emotion, etc. to be conveyed by the image, thereby better meeting the needs of users.

In step S106: music is determined according to the music description text.

Because the music description text includes the description information of the generated feature of the music, the music may be directly generated using the machine learning model according to the description information, or music that matches the generated feature of the music may be selected from a music database according to the description information.

In step S108: the multimedia content is generated according to the image and the music, and the multimedia content is displayed.

For example, a machine learning model may be used to generate multiple frames of video images according to the image, and then the multiple frames of video images and the music are edited, so that the multiple frames of video images and the music are aligned in terms of time and content, thereby generating the final multimedia content. The multimedia content may be displayed in the interaction interface between the user and the application or the agent.

According to the method in the foregoing embodiments, the image input by the user is understood in the plurality of attribute dimensions to generate the music description text, the music is determined according to the music description text, and the multimedia content is generated according to the image and the music. Because the music description text is generated based on understanding of the image in the plurality of attribute dimensions, the generated feature of the music described in the music description text is associated with the plurality of attribute dimensions of the image, so that the generated music matches the image, and the finally the generated multimedia content also matches the music. This may improve the presentation effect and audio-visual effect of the multimedia content as a whole, and better meet the needs of users. According to the method in the foregoing embodiments, the music may be directly determined and the multimedia content may be directly generated based on the image without the need for the user to select and add music, so that the efficiency of generating the multimedia content is improved while the presentation effect and audio-visual effect of the multimedia content are improved.

How to receive the image input is described below with reference to some embodiments.

In some embodiments, receiving the image input includes: displaying a camera control; in response toa triggering operation on the camera control, displaying a shooting preview interface, where the shooting preview interface includes a multimedia content generation option; and in response to a selection operation on the multimedia content generation option and triggering shooting of the image, receiving the image.

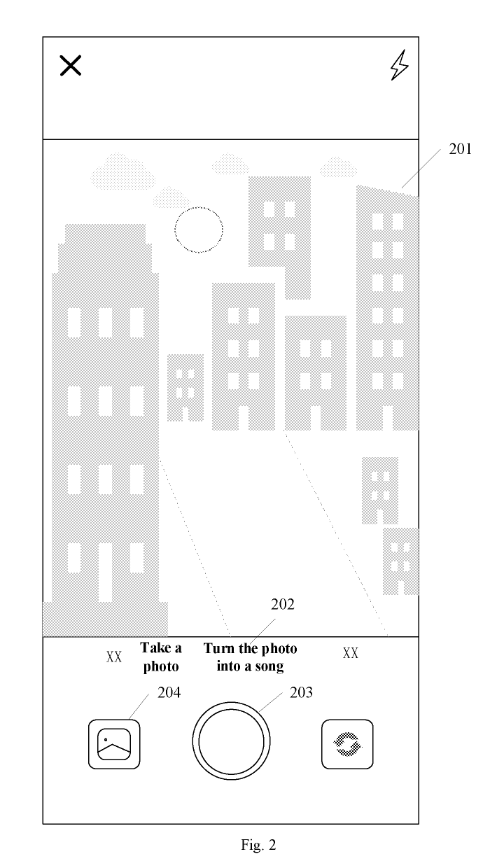

For example, the camera control is displayed in the interaction interface, and in response to a triggering operation on the camera control in the interaction interface, the shooting preview interface may be displayed, and an image captured by a camera lens may be displayed in the shooting preview interface. As shown in FIG. 2, which is the shooting preview interface, an image 201 captured by the camera lens may be displayed, a multimedia content generation option 202 may also be displayed, and other options such as "take a photo" may also be displayed. For example, the user may select the multimedia content generation option 202 through operations such as swiping and tapping. The shooting preview interface further includes a shooting control 203, and in response to the user triggering the shooting control 203, the image is shot and the shot image is acquired.

In response to the user triggering the shooting control 203, the confirmation control may also be displayed, for example, the shooting control is switched to the confirmation control for display. In response to the user triggering the confirmation control, the image is received and the subsequent multimedia content generation process is performed. Alternatively, in response to the user triggering the confirmation control, the image is displayed in the interaction interface (or a new interface, window, floating layer, mask layer, etc.), and the multimedia content generation control is displayed. In response to the user triggering the multimedia content generation control, the subsequent multimedia content generation process is performed.

Alternatively, the multimedia content generation control may be displayed in the interaction interface, or the shooting preview interface may be displayed through a multimedia content generation instruction. Only the multimedia content generation option may be displayed in the shooting preview interface, or only the shooting control may be displayed. The user may trigger the shooting control to trigger the generation of the multimedia content based on the image. The specific control setting manner and triggering manner may be set according to requirements, and are not limited to the foregoing examples.

According to the method in the foregoing embodiments, the user may directly take a photo and automatically generate the multimedia content including the music generated based on the taken photo, to implement turning a photo into a song. This improves the efficiency of generating the multimedia content, and the image and the music in the generated multimedia content match better, which meets the needs of the user.

In some embodiments, receiving the image includes: displaying an image selection control; in response to a triggering operation on the image selection control, displaying a plurality of candidate images; in response to a selection operation on the image in the plurality of candidate images, receiving and displaying the image and a multimedia content generation control; and receiving a trigger operation on the multimedia content generation control.

For example, the image selection control may be displayed in the interaction interface, or the image selection control 204 may be displayed in the preview interface shown in FIG. 2. In response to the user triggering the image selection control, the plurality of candidate images locally stored may be displayed, or certainly, there may be only one candidate image. The user may select an image through an operation such as tapping, the selected image may be displayed, and the multimedia content generation control may also be displayed. Then, the user triggers the multimedia content generation control to perform the subsequent multimedia content generation process.

In response to the user selecting the image, the confirmation control may also be displayed, for example, the shooting control is switched to the confirmation control for display. In response to the user triggering the confirmation control, the image is received, the image is displayed in the interaction interface (or a new interface, window, floating layer, mask layer, etc.), and the multimedia content generation control is displayed. In response to the user triggering the multimedia content generation control, the subsequent multimedia content generation process is performed. The specific control setting manner and triggering manner may be set according to requirements, and are not limited to the foregoing examples.

The user may shoot or select one or more images, that is, the user may input one or more images.

According to the method in the foregoing embodiments, the user may automatically generate the multimedia content by selecting an existing image, and the multimedia content includes the music generated based on the selected photo. This improves the efficiency of generating the multimedia content, and the image and the music in the generated multimedia content match better, which meets the needs of the user.

How to understand the image in the plurality of attribute dimensions to generate the music description text is specifically described below.

In some embodiments, generating a music description text by understanding the image in the plurality of attribute dimensions includes: generating an image description text by understanding the image in the plurality of attribute dimensions, where the image description text includes information of the plurality of attribute dimensions; and generating the music description text by semantically understanding the image description text, where the generated feature of the music is obtained based on the information of the plurality of attribute dimensions.

For example, a first machine learning model is used to understand the image in the plurality of attribute dimensions to generate the image description text. For example, the first machine learning model is an image-to-text model, which is not limited to the examples. For example, a second machine learning model is used to semantically understand the image description text to generate the music description text. For example, the second machine learning model is a large language model (Large Language Model, LLM), which is not limited to the examples. Because the generated feature of the music is obtained based on the information of the plurality of attribute dimensions, the generated feature of the music is closely associated and matched with the information of the plurality of attribute dimensions of the image.

According to the method in the foregoing embodiments, the image is deeply understood, and the information of the plurality of attribute dimensions of the image is converted into the generated feature of the music, to implement conversion from the image to the music description text. This improves the accuracy of the generated feature of the music, thereby improving the accuracy of the generated music and the degree of match with the image.

In some embodiments, generating the image description text by understanding the image in the plurality of attribute dimensions includes: determining information of the plurality of attribute dimensions among an entity, a scene, emotion, an environment, a theme, a style, and an effect element by understanding the image in the plurality of attribute dimensions among the entity, the scene, the emotion, the environment, the theme, the style, and the effect element in the image; and generating the image description text according to the information of the plurality of attribute dimensions.

The information of the plurality of attribute dimensions includes information of at least two attribute dimensions of the entity, the scene, the emotion, the environment, the theme, the style, and the effect element. For example, it is determined that the entity in the image includes the sun, a high-rise building, and a road, the scene is a city street, the emotion is loneliness, the environment is evening, the theme is a city in the sunset, the style is urban, and the effect element is a cold tone, which is not limited to the foregoing examples. The effect element may be used to represent an effect added to the image, and may include a color-related effect (for example, brightness, contrast, etc.), a light and shadow-related effect (for example, a shadow, luminescence, etc.), a clarity-related effect (for example, blurring, sharpening, etc.), and may also include effects such as a filter, color overlay, and inversion, which is not limited to the examples.

The image description text may be generated by performing structured processing on the information of the plurality of attribute dimensions, or may be obtained by integrating the information of the plurality of attribute dimensions according to a specific template. The information of the plurality of attribute dimensions may be extracted using the machine learning model. Therefore, the plurality of attribute dimensions may be determined by learning of the machine learning model, and may include other attribute dimensions than the foregoing examples, for example, an atmosphere of the image, and a relationship between the entities, which is not limited to the foregoing examples.

According to the method in the foregoing embodiments, the information of the plurality of attribute dimensions of the image may be accurately extracted, and the more accurate image description text may be generated, thereby improving the accuracy of the subsequent music description text.

In some embodiments, generating the music description text by semantically understanding the image description text includes: determining information of the plurality of attribute dimensions among the entity, the scene, the emotion, the environment, the theme, the style, and the effect element in the image by semantically understanding the image description text; determining the generated feature of the music that matches the information of the plurality of attribute dimensions among the entity, the scene, the emotion, the environment, the theme, the style, and the effect element, where the generated feature of the music includes at least one feature corresponding to at least one feature type of an atmosphere, a style, a rhythm, a melody, a harmony, a timbre, or vocals of the music; and generating the music description text according to the generated feature of the music.

The second machine learning model may be used to determine the generated feature of the music that matches the information of the plurality of attribute dimensions according to the information of the plurality of attribute dimensions of the image. For example, a feature corresponding to at least one feature type of the atmosphere or the style of the music may be determined first according to the information of the plurality of attribute dimensions. For example, it is determined that the atmosphere of the music is happy and the style of the music is classical, and then at least one feature corresponding to at least one feature type of the rhythm, the melody, the harmony, or the vocals of the music is determined according to the atmosphere and the style.

After the generated feature of the music is determined, structured processing may be performed on the generated feature to generate the music description text, or the generated feature of the music may be filled in a corresponding template to obtain the music description text, or the music description text may be generated in the form of rich text.

According to the method in the foregoing embodiments, the generated feature of the matching music may be determined according to the plurality of attribute dimensions of the image, to improve the accuracy of the generated feature of the music, thereby improving the degree of match between the subsequently generated music and the image and the degree of match between the subsequently generated music and the multimedia content.

The generated music may include lyrics. How to generate the description text of the music in a case where the music includes the lyrics is described below with reference to some embodiments.

In some embodiments, the music description text further includes the lyrics of the music, and generating the music description text according to the generated feature of the music includes: generating the lyrics of the music according to information of the plurality of attribute dimensions among the entity, the scene, the emotion, the environment, the theme, the style, and the effect element in the image and the generated feature of the music; and generating the music description text according to the generated feature of the music and the lyrics of the music.

A machine learning model may be used to generate the lyrics of the music according to the information of the plurality of attribute dimensions of the image and the generated feature of the music. The generated lyrics of the music match the information of the plurality of attribute dimensions of the image and the generated feature of the music, so that the features such as emotion and theme of the image may be better expressed, and the generated music may be more expressive and the hearing effect may be improved. Structured processing may be performed on the generated feature of the music and the lyrics of the music, or the generated feature of the music and the lyrics of the music may be filled in a corresponding template to obtain the music description text.

In some embodiments, generating the lyrics of the music according to the information of the plurality of attribute dimensions among the entity, the scene, the emotion, the environment, the theme, the style, and the effect element in the image and the generated feature of the music includes: determining a theme, emotion, and keywords of the lyrics according to the information of the plurality of attribute dimensions among the entity, the scene, the emotion, the environment, the theme, the style, and the effect element in the image and the generated feature of the music; and generating the lyrics of the music according to the theme, the emotion, and the keywords of the lyrics.

The theme, the emotion, and the keywords of the lyrics may be determined according to the information of the plurality of attribute dimensions of the image and the generated feature of the music. Further, the lyrics of the music may be generated according to the theme, the emotion, and the keywords of the lyrics and the generated feature of the music. The generated lyrics of the music may match the rhythm, the melody, the style, the duration, the structure, etc. of the music.

According to the method in the foregoing embodiments, the accuracy of the generated lyrics may be improved, and the generated lyrics may better match the information of the plurality of attribute dimensions of the image and the generated feature of the music, thereby improving the audio-visual effect of the subsequently generated multimedia content.

In a case where the music includes the lyrics, the lyrics of the music may also be generated first, and then the generated feature of the music is generated to generate the music description text. In some embodiments, the lyrics of the music are generated according to the information of the plurality of attribute dimensions of the image, the generated feature of the music is generated according to the information of the plurality of attribute dimensions of the image and the lyrics of the music, and the music description text is generated according to the lyrics of the music and the generated feature of the music.

For example, the theme, the emotion, and the keywords of the lyrics are determined according to the information of the plurality of attribute dimensions of the image, the lyrics are generated according to the theme, the emotion, and the keywords of the lyrics, and the generated feature of the music is generated according to the information of the plurality of attribute dimensions of the image and the lyrics.

Whether the music includes the lyrics may be configured by the user. In some embodiments, a lyrics generation control is displayed; and in response to a triggering operation on the lyrics generation control, among the lyrics of the music is generated by understanding the image in the plurality of attribute dimensions.

After the image is received, the image may be displayed in the interaction interface (or a new interface, window, floating layer, mask layer, etc.) and the lyrics generation control may be displayed (or only the lyrics generation control may be displayed), and the user triggers the lyrics generation control to trigger the function of generating the lyrics of the music. For how to specifically generate the lyrics, reference may be made to the foregoing embodiments, which are not described herein again. The user may also directly input the prompt for generating the lyrics to trigger the function of generating the lyrics of the music. For example, the image is displayed in the interaction interface, and an input area may also be displayed. In response to the user inputting the prompt for generating the lyrics, the image is understood in the plurality of attribute dimensions to generate the lyrics of the music.

According to the method in the foregoing embodiments, the user may trigger the generation of the lyrics of the music by simply triggering the lyrics generation control without the need for the user to input the prompt for the lyrics, thereby improving the efficiency of generating the lyrics and the convenience of operation.

Whether the music includes the lyrics may be configured by the user, and other features of the music may also be configured by the user. Some embodiments are described below.

In some embodiments, generating the music description text by understanding the image in the plurality of attribute dimensions includes: displaying a control corresponding to one or more candidate features, where in response to controls corresponding to a plurality of candidate features being displayed, the plurality of candidate features correspond to one or more feature types; and in response to a trigger operation on a control of one or more target candidate features in the one or more candidate features, generating the music description text according to the one or more target candidate features and understanding of the image in the plurality of attribute dimensions.

For example, the one or more controls of the one or more candidate features are displayed in various forms of interfaces such as the interaction interface, a new interface, a window, a floating layer, and a mask layer, which is not limited to the examples. For example, after the image is received, the image and the one or more controls corresponding to the one or more candidate features are displayed on the new interface. For another example, after the image is received, the image and one or more controls corresponding to one or more feature types are displayed on the new interface, and in response to the user triggering a control corresponding to a target feature type, the one or more candidate features corresponding to the target feature type or the one or more controls corresponding to the one or more candidate features are displayed. In response to the selection operation of the user on the one or more target candidate features or the trigger operation of the user on the control of the one or more target candidate features, the music description text is generated according to the one or more target candidate features and understanding of the image in the plurality of attribute dimensions.

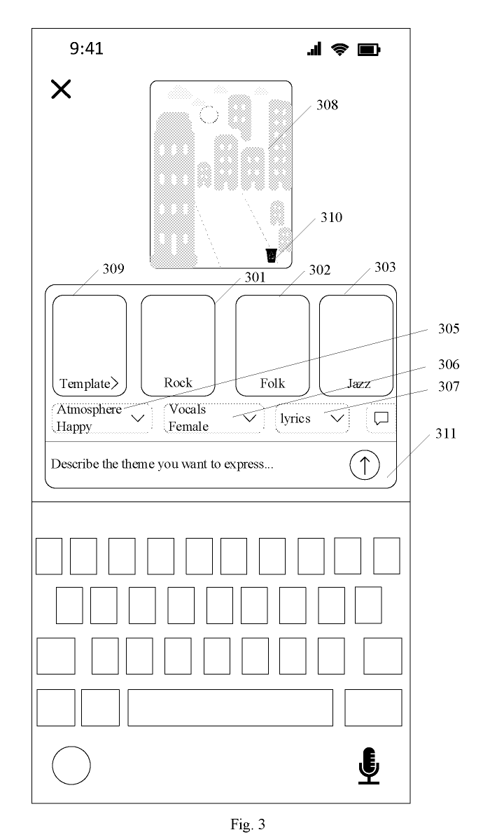

As shown in FIG. 3, the image 308 is displayed in the interface, and the controls 301 to 303 of the plurality of candidate features may also be displayed. The controls 301 to 303 of the candidate features may correspond to the same feature type, for example, the style. The user may select the style of the music to be rock, folk, or jazz by triggering the controls 301 to 303. The controls 301 to 303 of the candidate features may be controls of some candidate features. For example, in response to a preset operation of the user (for example, a swiping operation in a specific direction), controls of other candidate features may be displayed.

As shown in FIG. 3, the controls 305 to 306 of the plurality of feature types may be displayed in the interface, and the currently selected target candidate feature may be displayed in the control of each feature type. For example, in the control 305 corresponding to the feature type of atmosphere, the currently selected target candidate feature is "happy". In response to the user triggering the control of the target feature type, the one or more candidate features under the target feature type may be displayed in the form of a drop-down menu, and the user may select the target candidate feature. The controls 305 to 306 of the plurality of feature types may be only controls of some feature types, and for example, the controls of the feature types may be displayed in response to the preset operation (for example, the swiping operation in the specific direction) of the user.

As shown in FIG. 3, the lyrics generation control 307 may be displayed in the interface, options of having lyrics and no lyrics may be displayed in response to the user triggering the lyrics generation control 307, and "having lyrics" may be displayed in the lyrics generation control 307 in response to the user selecting the option of having lyrics. Alternatively, the lyrics generation control may be in a form of a switch or other forms, which is not limited to the examples.

As shown in FIG. 3, a template control 309 may also be displayed in the interface, and in response to the user triggering the template control 309, one or more templates may be displayed. Each template may include one or more determined features. In response to the user selecting a target template, the music description text is generated according to one or more features corresponding to the target template and the understanding of the image in the plurality of attribute dimensions.

As shown in FIG. 3, a deletion control 310 may also be displayed in the image display area, an image addition control may be displayed in response to the user triggering the deletion control 310, and one or more candidate images may be displayed or the camera control may be displayed in response to the user triggering the image addition control. The user may re-upload the image or shoot the image again.

In the foregoing embodiments, the method for displaying the control corresponding to the candidate feature and the feature type is merely an example, and other methods may be used in actual use.

For example, one or more reference features of the music may be determined according to the understanding of the image in the plurality of attribute dimensions, and the one or more reference features may be used as the one or more candidate features to be displayed in the interface. In addition, the one or more reference features may be displayed in a specific position. For example, the reference feature is displayed by default in the control of the feature type corresponding to the reference feature, or the reference feature is displayed at the first place in the ranking.

Because the one or more reference features obtained according to the understanding of the plurality of attribute dimensions of the image better meet the needs of the user, displaying these reference features in the specific position may enable the user to determine the target candidate feature more quickly and efficiently, thereby improving the efficiency of generating the multimedia content.

The one or more target candidate features selected by the user may be only some features for generating the music description text, and another part of the features may be generated in combination with the understanding of the image in the plurality of attribute dimensions, to generate the music description text.

According to the method in the foregoing embodiments, the user may select the one or more target candidate features, and the music description text is generated according to the one or more target candidate features in combination with the understanding of the plurality of attribute dimensions of the image, so that the generated feature of the music in the music description text better meets the needs of the user, and the subsequently generated multimedia content may provide a better audio-visual experience for the user.

The one or more target candidate features selected by the user may contradict or conflict with the features of the music obtained by understanding the image, and this situation needs to be determined and handled.

In some embodiments, generating the music description text according to the one or more target candidate features and the understanding of the image in the plurality of attribute dimensions includes: determining one or more generated features of the music according to the understanding of the image in the plurality of attribute dimensions; determining whether there is a generated feature that contradicts the one or more target candidate features by matching the one or more target candidate features with the one or more generated features; and in response to the presence of the generated feature that contradicts the one or more target candidate features, deleting the generated feature that contradicts the one or more target candidate features, and generating the music description text according to the one or more target candidate features and one or more remaining generated features.

The one or more target candidate features and the generated feature of the same feature type may be matched, and if they are inconsistent, the one or more target candidate features shall prevail. Ina case where the one or more target candidate features and the generated feature are of different feature types, if there is a contradiction between the one or more target candidate features and the generated feature, the generated feature is deleted, and the generated feature is re-generated according to the one or more target candidate features.

For determining the one or more generated features of the music according to the understanding of the image in the plurality of attribute dimensions, reference may be made to the foregoing embodiments, which are not described herein again.

If the one or more target candidate feature selected by the user satisfies the features required for generating the music description text or generating the music, the image may not be understood in the plurality of attribute dimensions.

According to the method in the foregoing embodiments, while referring to the one or more target candidate features selected by the user and the understanding of the image in the plurality of attribute dimensions, a contradiction between the one or more target candidate features and the understanding of the image in the plurality of attribute dimensions may be avoided, to prevent the generated music or multimedia content from being inaccurate and disordered, thereby improving the accuracy of the generated music or multimedia content and improving the audio-visual effect.

In addition to configuring some controls for the user to operate and select the one or more target candidate features in the foregoing embodiments, the user may also express the need for the music or multimedia content to be generated by inputting a prompt.

In some embodiments, the prompt of the multimedia content is received; and the music description text is generated according to the understanding of the plurality of attribute dimensions of the image and the prompt.

For example, after the image is received, the image may be displayed in the interaction interface, and the input area may also be displayed in the interaction interface. The user may input the prompt in the input area. For another example, as shown in FIG. 3, the image is displayed in the new interface, and an input area 311 may also be displayed. The user may input the prompt in the input area 311 in the form of voice, text, etc.

According to the method in the foregoing embodiments, the user may input the prompt, and the music description text is generated in combination with the understanding of the plurality of attribute dimensions of the image, so that the generated feature of the music in the music description text better meets the needs of the user, and the subsequently generated multimedia content may provide a better audio-visual experience for the user.

In some embodiments, the image description text is generated by understanding the image in the plurality of attribute dimensions , where the image description text includes information of the plurality of attribute dimensions; the prompt is semantically understood to determine whether the prompt includes a theme of the multimedia content; and in response to the prompt including the theme of the multimedia content, the music description text is generated according to the image description text and the theme of the multimedia content.

For example, at least one feature corresponding to at least one feature type of the atmosphere, the style, the rhythm, the melody, the harmony, the timbre, or the vocals of the music is determined according to information of the plurality of attribute dimensions among the entity, the scene, the emotion, the environment, the theme, the style, and the effect element in the image and the theme of the multimedia content, to generate the music description text.

According to the method in the foregoing embodiments, in a case where the user inputs the prompt, the music description text is generated in combination with the theme of the multimedia content in the prompt and the understanding of the plurality of attribute dimensions of the image, so that the generated feature of the music in the music description text better meets the needs of the user, and the subsequently generated multimedia content may provide a better audio-visual experience for the user.

In some embodiments, generating the music description text according to the understanding of the plurality of attribute dimensions of the image and the prompt further includes: determining whether the prompt information includes a target feature of the music by semantically understanding the prompt ; and in response to the prompt including the target feature of the music, generating the music description text according to the image description text, the theme of the multimedia content, and the target feature of the music.

If the prompt input by the user includes the target feature of the music, the music description text is generated in combination with the image description text, the theme of the multimedia content, and the target feature of the music. For example, the generated feature(s) of the music is determined according to the image description text and the theme of the multimedia content, the generated feature(s) of the music is matched with the target feature(s), and it is determined whether there is a generated feature(s) that contradicts the target feature(s). In response to the presence of the generated feature(s) that contradicts the target feature(s), the generated feature(s) that contradicts the target feature(s) is deleted, and the music description text is generated according to the target feature(s) and the remaining generated feature(s). If the prompt only includes the target feature(s) of the music, the music description text may be generated according to the image description text and the target feature(s).

In the foregoing embodiments, the music description text is generated in combination with the target feature of the music in the prompt, the theme of the multimedia content, and the image description text, so that the generated feature of the music in the music description text better meets the needs of the user, and the subsequently generated multimedia content may provide a better audio-visual experience for the user.

How to generate the multimedia content according to the image and the music is described below.

In some embodiments, generating the multimedia content according to the image and the music includes: determining a camera movement mode by understanding the image in the plurality of attribute dimensions; generating a plurality of frames of video images according to the image and the camera movement mode; and generating the multimedia content according to the multiple frames of video images and the music.

The multiple frames of video images may be generated using the machine learning model. For example, the machine learning model may be an image-to-video model. In addition to determining the camera movement mode, a plurality of shot scales may also be determined, for example, a close shot, a long shot, a medium shot, etc. The multiple frames of video images may be generated according to the image, the shot scales, and the camera movement mode. Further, the multiple frames of video images and the music are edited and fused to obtain the multimedia content.

According to the method in the foregoing embodiments, the camera movement mode is determined according to the understanding of the plurality of attribute dimensions of the image, and then the multiple frames of video images and the multimedia content are generated, so that the multimedia content may be more smooth and rich in terms of expression, and the audio-visual effect of the multimedia content may be improved.

In some embodiments, generating the multimedia content according to the image and the music includes: generating the image description text according to the understanding of the image in the plurality of attribute dimensions; expanding the image description text to generate a description text of the multiple frames of video images; generating the multiple frames of video images according to the description text of the multiple frames of video images; and generating the multimedia content according to the multiple frames of video images and the music.

A machine learning model (for example, an LLM) may be used to expand the image description text to generate the description text of the multiple frames of video images, and then the multiple frames of video images may be generated. The description text of the multiple frames of video images may include content, a shot scale, a camera movement mode, etc. of each frame of image.

According to the method in the foregoing embodiments, the image description text is expanded, so that the description text of the multiple frames of video images with richer content may be generated, thereby enriching the content of the generated multimedia content and improving the audio-visual effect.

In a case where the user inputs the prompt including the theme of the multimedia content or other needs, the multiple frames of video images are generated according to the prompt and the image. For example, the image is understood in the plurality of attribute dimensions and the prompt is understood to determine the camera movement mode; the multiple frames of video images are generated according to the image, the camera movement mode, and the prompt; and the multimedia content is generated according to the multiple frames of video images and the music. For another example, the image description text is generated according to the understanding of the image in the plurality of attribute dimensions and the prompt; the image description text is expanded to generate the description text of the multiple frames of video images; the multiple frames of video images are generated according to the description text of the multiple frames of video images; and the multimedia content is generated according to the multiple frames of video images and the music.

In the process of generating the multimedia content according to the multiple frames of video images and the music, it is necessary to match the duration of the multiple frames of video images with the duration of the music, and match the content of the multiple frames of video images with the content of the lyrics of the music, so as to achieve a better audio-visual effect of the multimedia content.

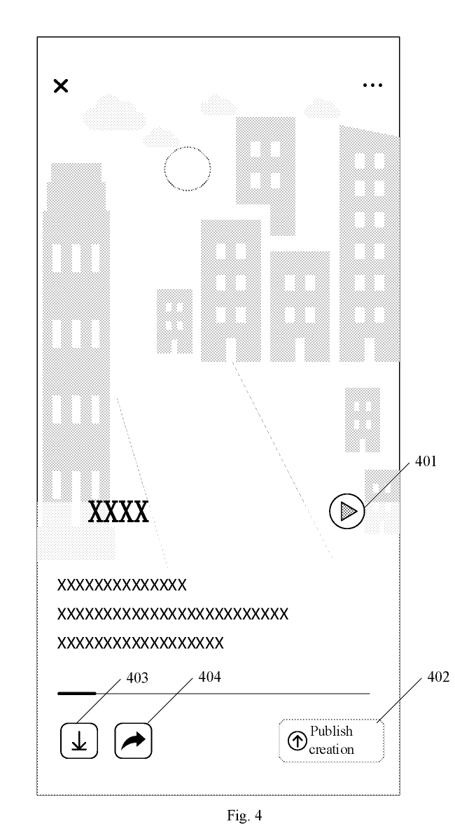

As shown in FIG. 4, a preview interface of the multimedia content may be displayed after the multimedia content is generated, and a play control 401 may be displayed in the preview interface, and the multimedia content is played in response to the user triggering the play control 401. A publishing control 402 may also be displayed in the preview interface, and one or more publishing channels may be displayed in response to the user triggering the publishing control 402. After the user selects a publishing channel, the multimedia content may be published through the selected publishing channel. A download control 403 and a sharing control 404 may also be displayed in the preview interface, and the user may download and save the multimedia content and share the multimedia content.

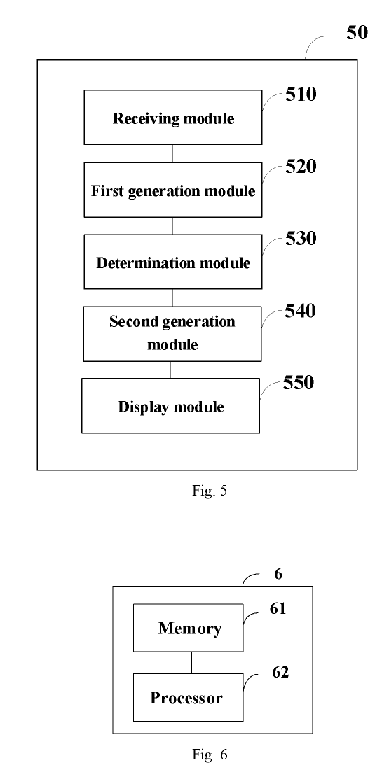

The present disclosure further provides a multimedia content generation apparatus, which is described below with reference to FIG. 5.

FIG. 5 is a structural diagram of some embodiments of a multimedia content generation apparatus according to the present disclosure. As shown in FIG. 5, the multimedia content generation apparatus 50 in this embodiment includes: a receiving module 510, a first generation module 520, a determination module 530, a second generation module 540, and a display module 550.

The receiving module 510 is configured to receive an image input by a user.

The first generation module 520 is configured to generate a music description text by understand the image in a plurality of attribute dimensions, where the music description text includes description information of a generated feature of music.

The determination module 530 is configured to determine music according to the music description text.

The second generation module 540 is configured to generate multimedia content according to the image and the music.

The display module 550 is configured to display the multimedia content.

The multimedia content generation apparatus in the foregoing embodiments may understand an image input by a user in a plurality of attribute dimensions to generate a music description text, determine music according to the music description text, and generate multimedia content according to the image and the music. Because the music description text is generated according to the understanding of the image in the plurality of attribute dimensions, a generated feature of the music described in the music description text is associated with the plurality of attribute dimensions of the image, so that the generated music matches the image, and the finally generated multimedia content also matches the music. This improves the presentation effect and the audio-visual effect of the multimedia content as a whole, and better meets the needs of the user. The generation apparatus in the foregoing embodiments may directly determine the music and generate the multimedia content based on the image, and does not require the user to select and add music, thereby improving the generation efficiency of the multimedia content while improving the presentation effect and the audio-visual effect of the multimedia content.

In some embodiments, the first generation module 520 is configured to generate an image description text by understanding the image in the plurality of attribute dimensions to generate an image description text, where the image description text includes information of the plurality of attribute dimensions; and generate the music description text by semantically understanding the image description text, where the generated feature of the music is obtained based on the information of the plurality of attribute dimensions.

In some embodiments, the first generation module 520 is configured to determine information of the plurality of attribute dimensions among the entity, the scene, the emotion, the environment, the theme, the style, and the effect element by understanding the image in the plurality of attribute dimensions among the scene, the emotion, the environment, the theme, the style, and the effect element in the image; and generate the image description text according to the information of the plurality of attribute dimensions.

In some embodiments, the first generation module 520 is configured to determine information of the plurality of attribute dimensions among the entity, the scene, the emotion, the environment, the theme, the style, and the effect element in the image by semantically understanding the image description text; determine the generated feature of the music that matches the information of the plurality of attribute dimensions among the entity, the scene, the emotion, the environment, the theme, the style, and the effect element, wherein the generated feature of the music comprises at least one feature corresponding to at least one feature type of an atmosphere, a style, a rhythm, a melody, a harmony, a timbre, or vocals of the music; and generate the music description text according to the generated feature of the music.

In some embodiments, the music description text further includes lyrics of the music, and the first generation module 520 is configured to generate the lyrics of the music according to information of the plurality of attribute dimensions among the entity, the scene, the emotion, the environment, the theme, the style, and the effect element in the image and the generated feature of the music; and generate the music description text according to the generated feature of the music and the lyrics of the music.

In some embodiments, the first generation module 520 is configured to determine a theme, emotion, and keywords of the lyrics according to the information of the plurality of attribute dimensions among the entity, the scene, the emotion, the environment, the theme, the style, and the effect element in the image and the generated feature of the music; and generate the lyrics of the music according to the theme, the emotion, and the keywords of the lyrics.

In some embodiments, the second generation module 540 is configured to determine a camera movement mode by understanding the image in the plurality of attribute dimensions; generate a plurality of frames of video images according to the image and the camera movement mode; and generate the multimedia content according to the multiple frames of video images and the music.

In some embodiments, the second generation module 540 is configured to generate the image description text according to the understanding of the image in the plurality of attribute dimensions; expand the image description text to generate a description text of the multiple frames of video images; generate the multiple frames of video images according to the description text of the multiple frames of video images; and generate the multimedia content according to the multiple frames of video images and the music.

In some embodiments, the display module 550 is configured to display a control corresponding to one or more candidate features, where in response to controls corresponding to a plurality of candidate features being displayed, the plurality of candidate features correspond to one or more feature types; and the first generation module 520 is configured to, in response to a trigger operation on a control of one or more target candidate features in the one or more candidate features, generate the music description text according to the one or more target candidate features and the understanding of the plurality of attribute dimensions of the image.

In some embodiments, the first generation module 520 is configured to determine one or more generated features of the music according to the understanding of the image in the plurality of attribute dimensions; determine whether there is a generated feature that contradicts the one or more target candidate features by matching the one or more target candidate features with the one or more generated features; and in response to the presence of the generated feature that contradicts the one or more target candidate features, delete the generated feature that contradicts the one or more target candidate features, and generate the music description text according to the one or more target candidate features and one or more remaining generated features.

In some embodiments, the music description text further includes the lyrics of the music, and the display module 550 is configured to display a lyrics generation control; and the first generation module 520 is configured to, in response to a triggering operation on the lyrics generation control, generate the lyrics of the music by understanding the image in the plurality of attribute dimensions.

In some embodiments, the receiving module 510 is further configured to receive a prompt of the multimedia content; and the first generation module 520 is configured to generate the music description text according to the understanding of the plurality of attribute dimensions of the image and the prompt.

In some embodiments, the first generation module 520 is configured to generate the image description text by understand the image in the plurality of attribute dimensions, where the image description text includes information of the plurality of attribute dimensions; determine whether the prompt information includes a theme of the multimedia content by semantically understanding the prompt ; and in response to the prompt information including the theme of the multimedia content, generate the music description text according to the image description text and the theme of the multimedia content.

In some embodiments, the first generation module 520 is configured to determine whether the prompt includes a target feature of the music by semantically understand the prompt ; and in response to the prompt including the target feature of the music, generate the music description text according to the image description text, the theme of the multimedia content, and the target feature of the music.

In some embodiments, the display module 550 is configured to display an image selection control; display a plurality of candidate images in response to a triggering operation on the image selection control; and the receiving module 510 is configured to, in response to a selection operation on the image in the plurality of candidate images receive and display the image and a multimedia content generation control; and receive a trigger operation on the multimedia content generation control.

In some embodiments, the display module 550 is configured to display a camera control; display a shooting preview interface in response to a triggering operation on the camera control, where the shooting preview interface includes a multimedia content generation option; and the receiving module 510 is configured to receive the image in response to a selection operation on the multimedia content generation option and triggering shooting of the image.

The present disclosure further provides an electronic device, including: a processor; and a memory coupled to the processor and configured to store instructions, where the instructions, when executed by the processor, cause the processor to implement the multimedia content generation method according to any one of the embodiments of the present disclosure.

The electronic device of the present disclosure may understand an image input by a user in a plurality of attribute dimensions to generate a music description text, determine music according to the music description text, and generate multimedia content according to the image and the music. Because the music description text is generated according to the understanding of the image in the plurality of attribute dimensions, a generated feature of the music described in the music description text is associated with the plurality of attribute dimensions of the image, so that the generated music matches the image, and the finally the generated multimedia content also matches the music. This improves the presentation effect and the audio-visual effect of the multimedia content as a whole, and better meets the needs of the user. The electronic device of the present disclosure may directly determine the music and generate the multimedia content based on the image, and does not require the user to select and add music, thereby improving the generation efficiency of the multimedia content while improving the presentation effect and the audio-visual effect of the multimedia content.

The present disclosure further provides a computer-readable storage medium, where a computer program is stored on the computer-readable storage medium, and the computer program, when executed by a processor, implements the multimedia content generation method according to any one of the embodiments of the present disclosure.

The computer-readable storage medium of the present disclosure may understand an image input by a user in a plurality of attribute dimensions to generate a music description text, determine music according to the music description text, and generate multimedia content according to the image and the music. Because the music description text is generated according to the understanding of the image in the plurality of attribute dimensions, a generated feature of the music described in the music description text is associated with the plurality of attribute dimensions of the image, so that the generated music matches the image, and the finally the generated multimedia content also matches the music. This improves the presentation effect and the audio-visual effect of the multimedia content as a whole, and better meets the needs of the user. The computer-readable storage medium of the present disclosure may directly determine the music and generate the multimedia content based on the image, and does not require the user to select and add music, thereby improving the generation efficiency of the multimedia content while improving the presentation effect and the audio-visual effect of the multimedia content.

The present disclosure further provides a computer program product, including: instructions, where the instructions, when executed by a processor, cause the processor to implement the multimedia content generation method according to any one of the embodiments of the present disclosure.

The computer program product of the present disclosure may understand an image input by a user in a plurality of attribute dimensions to generate a music description text, determine music according to the music description text, and generate multimedia content according to the image and the music. Because the music description text is generated according to the understanding of the image in the plurality of attribute dimensions, a generated feature of the music described in the music description text is associated with the plurality of attribute dimensions of the image, so that the generated music matches the image, and the finally the generated multimedia content also matches the music. This improves the presentation effect and the audio-visual effect of the multimedia content as a whole, and better meets the needs of the user. The computer program product of the present disclosure may directly determine the music and generate the multimedia content based on the image, and does not require the user to select and add music, thereby improving the generation efficiency of the multimedia content while improving the presentation effect and the audio-visual effect of the multimedia content.

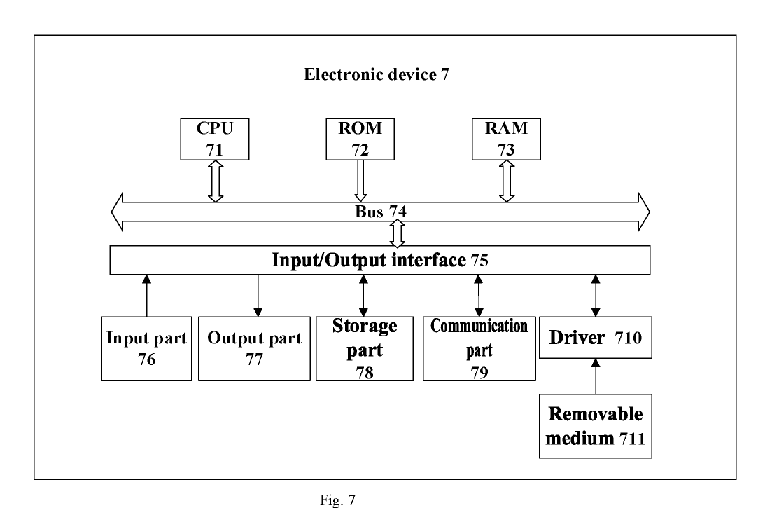

The electronic device of the present disclosure is described below with reference to FIGS. 6 and 7. FIG. 6 is a block diagram of an electronic device according to some embodiments of the present disclosure.

The memory 61 is used to store one or more computer-readable instructions. The memory 61 may include any combination of various forms of computer-readable storage media, such as volatile memory and/or non-volatile memory, including but not limited to random access memory (RAM), dynamic random access memory (DRAM), static random access memory (SRAM), read-only memory (ROM), and flash memory. The memory 61 may store, for example, an operating system, an application, a boot loader, a database, and other programs, and may also store various applications, various data, and the like.

The processor 62 is used to run the computer-readable instructions to implement the method according to any one of the foregoing embodiments. For the specific implementation of each step of the method, reference may be made to the foregoing embodiments, and details of the same parts are not repeated herein.

The processor 62 may be embodied as various processing apparatuses, such as a central processing unit (CPU) and a network processor (NP); and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 62 and the memory 61 may directly or indirectly communicate with each other. For example, the processor 62 and the memory 61 may communicate through a network. The network may include a wireless network, a wired network, and/or any combination of a wireless network and a wired network. The processor 62 and the memory 61 may also communicate with each other through a system bus, which is not limited in the present disclosure.

It should be noted that the components of the electronic device 6 shown in FIG. 6 are merely exemplary and non-restrictive, and the electronic device 6 may further have other components according to actual application requirements. The processor 62 may control other components in the electronic device 6 to perform desired functions.

The electronic device 6 may be implemented by means of software, firmware, and/or hardware, and may be integrated into apparatuses installed with related applications.

FIG. 7 is a block diagram of an electronic device according to some other embodiments of the present disclosure.

The electronic device 7 shown in FIG. 7 may be a computer system with a dedicated hardware structure, and may perform corresponding functions when installed with relevant applications.

The electronic device includes, but is not limited to, mobile terminals such as a smartphone, a notebook computer, a personal digital assistant (PDA), a tablet computer, a portable media player (PMP), a vehicle-mounted terminal (e.g., a vehicle navigation terminal), and a wearable device, and fixed terminals such as a digital television and a desktop computer.

As shown in FIG. 7, a central processing unit (CPU) 71 performs various processes according to a program stored in a read-only memory (ROM) 72 or a program loaded from a storage portion 78 into a random access memory (RAM) 73. The RAM 73 stores data required when the CPU 71 performs the various processes, as needed. The central processing unit is merely exemplary, and it may also be other types of processors, such as the various processors described above. The ROM 72, the RAM 73, and the storage portion 78 may be various forms of computer-readable storage media. It should be noted that although the ROM 72, the RAM 73, and the storage portion 78 are shown separately in FIG. 7, one or more of them may be combined, or located in the same or different memories or storage modules.

The CPU 71, the ROM 72, and the RAM 73 are connected to each other via a bus 74. An input/output interface 75 is also connected to the bus 74.

The following components are connected to the input/output interface 75: an input portion 76, such as a touch screen, a touchpad, a keyboard, a mouse, an image sensor, a microphone, an accelerometer, and a gyroscope; an output portion 77, including a display, such as a cathode ray tube (CRT) and a liquid crystal display (LCD), a speaker, a vibrator, and the like; the storage portion 78, including a hard disk, a magnetic tape, and the like; and a communication portion 79, including a network interface card, such as a LAN card and a modem. The communication portion 79 allows communication processing to be performed via a network such as Internet. It is easily understood that although the components in the electronic device 7 shown in FIG. 7 communicate through the bus 74, they may also communicate through a network or other means, where the network may include a wireless network, a wired network, and/or any combination of a wireless network and a wired network.

A drive 710 is also connected to the input/output interface 75 as needed. A removable medium 711, such as a magnetic disk, an optical disk, a magneto-optical disk, and a semiconductor memory, is installed on the drive 710 as needed, so that a computer program read therefrom is installed into the storage portion 78 as needed.

In the case where the above series of processes are implemented by software, a program that constitutes the software may be installed from a network such as Internet or a storage medium such as the removable medium 711.

According to the embodiments of the present disclosure, the process described above with reference to the flowchart may be implemented as a computer software program. For example, some embodiments of the present disclosure include a computer program product, which, when running on a computer, causes the computer to implement the method according to any one of the foregoing embodiments. The computer program product includes computer instructions carried on a computer-readable medium, and includes program code for performing the method shown in the flowchart. In such an embodiment, the computer instructions may be downloaded and installed from a network through the communication portion 79, or installed from the storage portion 78, or installed from the ROM 72. When the computer program is executed by the CPU 71, the method of the embodiments of the present disclosure is executed.

It should be noted that in the context of the present disclosure, the computer-readable medium may be a tangible medium that may include or store a program for use by or in combination with an instruction execution system, apparatus, or device.

The computer-readable medium may be a computer-readable storage medium, a computer-readable signal medium, or any combination thereof.

The computer-readable storage medium includes, but is not limited to, an electrical, magnetic, optical, electromagnetic, infrared, or semiconductor system, apparatus, or device, or any suitable combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. Computer instructions are stored on the computer-readable storage medium, and the instructions, when executed by a processor, implement the method according to any one of the foregoing embodiments.

The computer-readable signal medium may include a data signal propagated on a baseband or as a part of a carrier, and computer-readable program code is carried in the data signal. The data signal propagated in this manner may be in a plurality of forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program for use by or in combination with an instruction execution system, apparatus, or device. The program code contained on the computer-readable medium may be transmitted by any suitable medium, including but not limited to: a wire, an optical cable, a radio frequency (RF), or any suitable combination thereof.

The computer-readable medium may be included in the electronic device, or may exist alone without being assembled into the electronic device.

In some embodiments, a computer program is further provided, including: instructions, where the instructions, when executed by a processor, cause the processor to implement the method according to any one of the foregoing embodiments. For example, the instructions may be embodied as computer program code.

In the embodiments of the present disclosure, the computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as "C" language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving a remote computer, the remote computer may be connected to a computer of a user through any kind of network, including a local area network (LAN) or a wide area network (WAN), or may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the block may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), etc.

Although some specific embodiments of the present disclosure have been described in detail by way of examples, those skilled in the art should understand that the above examples are only for illustration, and are not intended to limit the scope of the present disclosure. Those skilled in the art should understand that the foregoing embodiments may be modified without departing from the scope and spirit of the present disclosure. The scope of the present disclosure is defined by the appended claims.

What is claimed is:

1. A multimedia content generation method, comprising:
receiving an image ;
generating a music description text by understanding the image in a plurality of attribute dimensions, wherein the music description text comprises description information of a generated feature of music;
determining the music according to the music description text; and
generating the multimedia content according to the image and the music, and displaying the multimedia content.

2. The multimedia content generation method according to claim 1, wherein generating a music description text by understanding the image in the plurality of attribute dimensions t comprises:
generating an image description text by understanding the image in the plurality of attribute dimensions , wherein the image description text comprises information of the plurality of attribute dimensions; and
generating the music description text by semantically understanding the image description text , wherein the generated feature of the music is obtained based on the information of the plurality of attribute dimensions.

3. The multimedia content generation method according to claim 2, wherein generating the image description text by understanding the image in the plurality of attribute dimensions comprises:
determining information of the plurality of attribute dimensions among an entity, a scene, emotion, an environment, a theme, a style, and an effect element by understanding the image in the plurality of attribute dimensions among the entity, the scene, the emotion, the environment, the theme, the style, and the effect element in the image; and
generating the image description text according to the information of the plurality of attribute dimensions.

4. The multimedia content generation method according to claim 3, wherein generating the music description text by semantically understanding the image description text comprises:
determining information of the plurality of attribute dimensions among the entity, the scene, the emotion, the environment, the theme, the style, and the effect element in the image by semantically understanding the image description text;
determining the generated feature of the music that matches the information of the plurality of attribute dimensions among the entity, the scene, the emotion, the environment, the theme, the style, and the effect element, wherein the generated feature of the music comprises at least one feature corresponding to at least one feature type of an atmosphere, a style, a rhythm, a melody, a harmony, a timbre, or vocals of the music; and
generating the music description text according to the generated feature of the music.

5. The multimedia content generation method according to claim 4, wherein the music description text further comprises lyrics of the music, and generating the music description text according to the generated feature of the music comprises:
generating the lyrics of the music according to information of the plurality of attribute dimensions among the entity, the scene, the emotion, the environment, the theme, the style, and the effect element in the image and the generated feature of the music; and
generating the music description text according to the generated feature of the music and the lyrics of the music.

6. The multimedia content generation method according to claim 5, wherein generating the lyrics of the music according to information of the plurality of attribute dimensions among the entity, the scene, the emotion, the environment, the theme, the style, and the effect element in the image and the generated feature of the music comprises:
determining a theme, emotion, and keywords of the lyrics according to the information of the plurality of attribute dimensions among the entity, the scene, the emotion, the environment, the theme, the style, and the effect element in the image and the generated feature of the music; and
generating the lyrics of the music according to the theme, the emotion, and the keywords of the lyrics.

7. The multimedia content generation method according to claim 1, wherein generating the multimedia content according to the image and the music comprises:
determining a camera movement mode by understanding the image in the plurality of attribute dimensions;
generating a plurality of frames of video images according to the image and the camera movement mode; and
generating the multimedia content according to the multiple frames of video images and the music.

8. The multimedia content generation method according to claim 1, wherein generating the multimedia content according to the image and the music comprises:
generating an image description text according to the understanding of the image in the plurality of attribute dimensions;
expanding the image description text to generate a description text of the multiple frames of video images;
generating the multiple frames of video images according to the description text of the multiple frames of video images; and
generating the multimedia content according to the multiple frames of video images and the music.

9. The multimedia content generation method according to claim 1, wherein generating the music description text by understanding the image in the plurality of attribute dimensions to comprises:
displaying a control corresponding to one or more candidate features, wherein in response to controls corresponding to a plurality of candidate features being displayed, the plurality of candidate features correspond to one or more feature types;
generating the music description text according to one or more target candidate features and the understanding of the plurality of attribute dimensions of the image, in response to a trigger operation on one or more controls of the one or more target candidate features in the one or more candidate features,.

10. The multimedia content generation method according to claim 9, wherein generating the music description text according to the one or more target candidate features and the understanding of the plurality of attribute dimensions of the image comprises:
determining one or more generated features of the music according to the understanding of the plurality of attribute dimensions of the image;
determining whether there is a generated feature that contradicts the one or more target candidate features by matching the one or more target candidate features with the one or more generated features;
deleting the generated feature that contradicts the one or more target candidate features, and generating the music description text according to the one or more target candidate features and one or more remaining generated features, in response to a presence of the generated feature that contradicts the one or more target candidate features.

11. The multimedia content generation method according to claim 1, wherein the music description text further comprises lyrics of the music, and generating the music description text by understanding the image in the plurality of attribute dimensions comprises:
displaying a lyrics generation control; and
generating the lyrics of the music by understanding the image in the plurality of attribute dimensions in response to a triggering operation on the lyrics generation control.

12. The multimedia content generation method according to claim 1, wherein generating the music description text by understanding the image in the plurality of attribute dimensions comprises:
receiving a prompt of the multimedia content; and
generating the music description text according to the understanding of the plurality of attribute dimensions of the image and the prompt.

13. The multimedia content generation method according to claim 12, wherein generating the music description text according to the understanding of the plurality of attribute dimensions of the image and the prompt comprises:
generating an image description text by understanding the image in the plurality of attribute dimensions, wherein the image description text comprises information of the plurality of attribute dimensions;
determining whether the prompt comprises a theme of the multimedia content by semantically understanding the prompt; and
generating the music description text according to the image description text and the theme of the multimedia content, in response to the prompt comprising the theme of the multimedia content.

14. The multimedia content generation method according to claim 13, wherein generating the music description text according to the understanding of the plurality of attribute dimensions of the image and the prompt further comprises:
determining whether the prompt comprises a target feature of the music by semantically understanding the prompt;
generating the music description text according to the image description text, the theme of the multimedia content, and the target feature of the music, in response to the prompt comprising the target feature of the music,.

15. The multimedia content generation method according to claim 1, wherein receiving the image comprises:
displaying an image selection control;
displaying a plurality of candidate images, in response to a triggering operation on the image selection control;
receiving and displaying the image and a multimedia content generation control, in response to a selection operation on the image in the plurality of candidate images; and
receiving a trigger operation on the multimedia content generation control.

16. The multimedia content generation method according to claim 1, wherein receiving the image comprises:
displaying a camera control;
displaying a shooting preview interface, in response to a triggering operation on the camera control, wherein the shooting preview interface comprises a multimedia content generation option; and
receiving the image, in response to a selection operation on the multimedia content generation option and a triggering operation for shooting the image.

17. An electronic device, comprising:
one or more processors; and
one or more memories coupled to the one or more processors and configured to store instructions, wherein the instructions, when executed by the one or more processors, cause the one or more processors to:
receive an image;
generate a music description text by understanding the image in a plurality of attribute dimensions , wherein the music description text comprises description information of a generated feature of music;
determine the music according to the music description text; and
generate the multimedia content according to the image and the music, and display the multimedia content.

18. The electronic device according to claim 17, wherein generating a music description text by understanding the image in the plurality of attribute dimensions t comprises:
generating an image description text by understanding the image in the plurality of attribute dimensions , wherein the image description text comprises information of the plurality of attribute dimensions; and
generating the music description text by semantically understanding the image description text , wherein the generated feature of the music is obtained based on the information of the plurality of attribute dimensions.

19. A non-transitory computer-readable storage medium, wherein a computer program is stored on the computer-readable storage medium, and the computer program, when executed by a processor, causes the processor to:
receive an image;
generate a music description text by understanding the image in a plurality of attribute dimensions , wherein the music description text comprises description information of a generated feature of music;
determine the music according to the music description text; and
generate the multimedia content according to the image and the music, and display the multimedia content.

20. The non-transitory computer-readable storage medium according to claim 19, wherein generating a music description text by understanding the image in the plurality of attribute dimensions t comprises:
generating an image description text by understanding the image in the plurality of attribute dimensions , wherein the image description text comprises information of the plurality of attribute dimensions; and
generating the music description text by semantically understanding the image description text , wherein the generated feature of the music is obtained based on the information of the plurality of attribute dimensions.
